(19) United States
(12) Patent Application Publication
(10) Pub. No.: US 2024/0391325 A1
(43) Pub. Date: Nov. 28, 2024

(54) METHOD FOR OPERATING A COMMERCIAL VEHICLE COMBINATION, AND COMMERCIAL VEHICLE COMBINATION

(71) Applicant: ZF CV Systems Global GmbH, Bern (CH)

(72) Inventors: Felix Müller-Deile, Hannover (DE); Janik Ricke, Uetze (DE)

(21) Appl. No.: 18/794,770

(22) Filed: Aug. 5, 2024

Related U.S. Application Data
(63) Continuation of application No. PCT/EP2023/050271, filed on Jan. 9, 2023.

(30) Foreign Application Priority Data
Feb. 3, 2022 (DE) 10 2022 102 574.8

(51) Int. Cl. B60L 15/20; B60K 1/02; B60L 7/10; B60L 50/75; B60L 58/12; H01M 8/04537; H01M 8/04858; H01M 10/42; H01M 10/44; H01M 16/00

(52) U.S. Cl. CPC B60L 15/20; B60K 1/02; B60L 7/10; B60L 50/75; B60L 58/12; H01M 8/04626; H01M 8/04925; H01M 10/425; H01M 10/44; H01M 16/006; B60L 2200/28; H01M 2010/4271; H01M 2220/20; H01M 2250/20; H01M 2250/402

(57) ABSTRACT

A method is for operating a commercial vehicle combination including a tractor, which has a first electric machine, a first electric storage device operatively connected to the latter, and a fuel cell system, which is operatively connected to the first electric storage device and is configured to provide electric energy with a generated power, and including a trailer, which has a second electric machine and a second electric storage device operatively connected to the latter. The method includes the following steps: determining operating parameters of the first and/or the second electric machine and/or operating parameters of the first and/or the second electric storage device; and, adapting the generated power of the fuel cell system as a function of one or more or all of the operating parameters determined. A commercial vehicle combination can also use such a method when in operation.

### CROSS-REFERENCE TO RELATED APPLICATIONS

This application is a continuation application of international patent application PCT/EP2023/050271, filed Jan. 9, 2023, designating the United States and claiming priority from German application 10 2022 102 574.8, filed Feb. 3, 2022, and the entire content of both applications is incorporated herein by reference.

### TECHNICAL FIELD

The disclosure relates to a method for operating a commercial vehicle combination including a tractor, which has a first electric machine, a first electric storage device operatively connected to the latter, and a fuel cell system, which is operatively connected to the first electric storage device and is configured to provide electric energy with a generated power, and including a trailer, which has a second electric machine and a second electric storage device operatively connected to the latter.

### BACKGROUND

During the operation of commercial vehicle combinations of the type designated above, changes in the load requirements on the fuel cell systems used in the tractors often occur. Changes in the load requirements are also included in the overarching term “dynamic loading”. The more dynamic the loading on the fuel cell system during operation, for example, on account of a route-section topography on the route followed by the commercial vehicle combination, the higher are also the dynamic requirements on the supply of reactants to the fuel cell system, for example, on the air supply. On the one hand, the size of compressors and compressor assemblies that can be used in commercial vehicles is limited in terms of installation space and, on the other hand, larger compressor assemblies are less dynamic than smaller compressor assemblies. However, fuel cell systems of commercial vehicle combinations require relatively large compressor systems, resulting in an increased air requirement.

Owing to the resulting limits on the dynamic response, the fuel cell systems in commercial vehicle combinations cannot respond particularly quickly, that is, in a particularly dynamic way, to changes in load requirements. Moreover, dynamic stressing of the fuel cell systems compromises the service life of these systems.

Despite the continuously increasing functionality of fuel cell systems in commercial vehicles, there is a perceived need for improvements here.

DE 10 2014 224 380 A1 discloses a cooling system for a fuel cell installation in which navigation information is used to determine the driving cycle and, on this basis, to ascertain the coolant requirement.

The fundamental problems associated with the limited dynamic loading capacity of fuel cell systems are likewise known from DE 10 2014 217 780 A1. There, it is proposed that operating parameters that will be needed for operation in future be predicted to enable a better estimation of an impending load requirement. Assessments of load changes are performed by drivers, and, according to the proposal in DE 10 2014 217 780 A1, diversion information, hilly terrain and traffic jams can be predicted via navigation systems.

DE 10 2017 109 410 A1 discloses a proposal according to which charging and discharging profiles of electric energy storage devices are to be recorded, and the future demand is to be determined from these via a prediction unit.

The prior art discloses various approaches which relate in general to improved operation of a tractor having fuel cell systems. However, none of the above proposes a concrete solution and they are therefore not optimal for the actual operation of commercial vehicle combinations consisting of a tractor and a trailer with a separate electric drive.

### SUMMARY

Accordingly, it is an object of the disclosure to specify a method which largely overcomes the disadvantages described above. In particular, it was an underlying object of the disclosure to specify a method for operating a commercial vehicle combination which allows more efficient operation of the commercial vehicle combination without compromising the service life of the fuel cell system of the tractor.

The disclosure achieves its underlying object by virtue of the fact that the method includes the following steps:
determining operating parameters of at least one electric machine of the combination, in particular of the first and/or the second electric machine, and/or operating parameters of at least one electric storage device of the combination, in particular of the first electric storage device and/or of the second electric storage device; and
adapting the generated power of the fuel cell system as a function of one or more or all of the operating parameters determined.

The disclosure is based on the idea that, to adapt the generated power to be provided by the fuel cell, the electric operating parameters of the overall system consisting of the tractor and trailer are determined, and thus the trailer component of the commercial vehicle combination with its dedicated electric machine and its dedicated energy storage device can be included as part of the overall system in the control of the generated power of the fuel cell. The trailer and its electric power components are thus made visible for control of the fuel cell system of the tractor. Via its electric machine, the trailer can make available additional driving power in the normal operating mode and additional regenerated power in the regeneration mode. To enable the potential of the combination consisting of the tractor and trailer to be fully exploited, the disclosure follows the approach of jointly considering the storage capacities of the two electric machines and the output capacity of the electric machines in order to appropriately adapt the generated power to be provided by the fuel cell. The control allows lower loading of the fuel cell on average over the service life of the fuel cell system and, on account of the larger amount of electric energy that can be stored, improved energy buffering because regeneration is improved and the adaptation of the generated power makes possible less dynamic loading of the fuel cell system.

The tractor and the trailer can each have an electric machine or can each have a plurality of electric machines, just as they can each have one or more electric storage devices. As regards the method, it is of course the case that, when a plurality of electric machines and/or electric storage devices is used, the determination of operating parameters can be carried out for one or more or all of the electric machines and/or electric storage devices.

In various embodiments, determination can include reading out permanently stored information or data and/or the acquisition of state variables from the continuous operation of the electric machine(s) or storage devices.

When the term “fuel cell system” is used in connection with the disclosure, this is understood to mean that the fuel cell system has a fuel cell that is configured to be operated at a variable operating point, wherein the operating point is adjusted as a function of one or more of the above-described operating parameters, preferably by a fuel cell controller.

The fuel cell controller is part of a higher-level vehicle controller which, in addition to the fuel cell controller, can have one or more further control units, for instance, one or more or all of the following:
battery management system, tractor braking control unit and/or trailer braking control unit.

The vehicle controller can be controlled as a central computer-aided fuel cell controller and can have the abovementioned units as components integrated in the form of hardware or software, or can be in the form of a plurality of dedicated control units which jointly perform the method according to the disclosure and, for this purpose, are provided with the corresponding processors, data memories and programmed control commands.

The method has two characteristic operating phases, a normal operating mode, in which the electric machines are operated as electric motors for driving the commercial vehicle combination, and a regeneration mode, in which the electric machines are operated as generators for regenerative braking. In other words, the method also includes the following steps at certain times:
providing electric energy with a generated power via the fuel cell system, and optionally
a) driving the commercial vehicle combination in a normal operating mode while drawing electric energy with a driving power from the first and/or the second electric storage device, and/or
b) providing electric energy with a regenerated power via the first and/or the second electric machine, and feeding the energy to the first and/or the second electric storage device in a regeneration mode.

In a further embodiment of the disclosure, the operating parameters include one or more or all of the following:
i) total capacity of the first and the second electric storage device,
ii) total state of charge of the first and the second electric storage device,
iii) total driving power of the first and the second electric machine,
iv) total regenerated power of the first and the second electric machine,
v) maximum driving power of the first electric machine,
vi) maximum driving power of the second electric machine,
vii) maximum (first) regenerated power of the first electric machine,
iix) maximum (second) regenerated power of the second electric machine,
ix) maximum (first) charging power of the first electric storage device,
x) maximum (second) charging power of the second electric storage device,
xi) maximum (first) braking power of the first electric machine, and/or
xii) maximum (second) braking power of the second electric machine.

The maximum regenerated power is limited, on the one hand, by the output capacity of the electric machines and, on the other hand, by the maximum charging power of the respective batteries. If, for example, there is an electric machine with a maximum power of 450 kW in the tractor, it is also generally not possible to provide more than that 450 kW of regenerated power. A similar consideration applies to the electric machines in the trailer. If, for example, an electric machine with a maximum power of 250 kW is provided there, it is also only possible to achieve a corresponding maximum regenerated power there.

The maximum braking power of the electric machines of the commercial vehicle combination is preferably stored in the vehicle controller, in particular in the fuel cell controller.

A set of information elements is preferably provided for the trailer, for example, likewise in the vehicle controller, and/or on or in the tractor, from which elements it is apparent to the vehicle controller, in particular to the fuel cell controller, what kind of trailer has been attached to the tractor and, above all, what kind of electric machine and what kind of electric storage device are therefore provided by the trailer.

The available braking power is preferably determined from the maximum motor torque that can be provided by the electric machines at the respectively current motor speed. This information can be transmitted via a BUS system, for example.

The maximum possible regenerated power can additionally be limited by the energy storage device, for example. It is not possible to feed in more regenerated power than the maximum amount of charging power that the electric storage devices can absorb. The maximum possible charging power of the energy storage devices is dependent on the respective current state of charge and other configuration-specific battery variables, such as the charging rate (C rate), the internal resistance of the cells within the energy storage devices et cetera.

The total capacity of the energy storage devices and the power ratings of the electric machines, in particular of the trailer, can be determined by way of coded information, for example, barcodes et cetera, applied to the trailer.

In an embodiment, the generated power is additionally adapted in accordance with an operating strategy, wherein the operating strategy has a time characteristic. The operating strategy includes a prediction of the driving power and/or of the provided regenerated power along the time characteristic. Thus, for example, the prediction can include future changes in the driving powers of the first and/or the second electric machine, the total driving power, the regenerated powers of the first and/or the second electric machine, and/or the total regenerated power.

In another embodiment, the operating strategy includes a prediction of the states of charge of the first and/or the second electric storage device along the time characteristic, in particular a prediction concerning changes in the state of charge of the first and/or the second electric storage device occurring along the time characteristic.

In another embodiment, the method includes the following steps: determining route-section information along the time characteristic, and adapting the generated power in addition in accordance with the route-section information determined. The route-section information can be determined over predetermined route-section profiles, which can be read out from a fleet management system or from a topographic cruise control, for example. From the route-section information, the vehicle controller can determine the energy demand for the commercial vehicle combination over the entire route-section profile, for example, via the fuel cell controller. In this aspect, the characterizing feature of the disclosure is the fact that the trailer can significantly assist the tractor by the additional provision of the driving power and the additional absorption of energy in the regeneration mode. This lowers the required generated power that must be provided by the fuel cell system. If a trailer with its own energy storage device and its own electric machine were attached to a conventional tractor with an internal combustion engine, a reduced fuel consumption by the tractor would likewise be observed there on account of the additional driving power and regenerated power of the trailer, although this would be due solely to the mechanical effect that the trailer assists the tractor in driving and regeneration.

In contrast to internal combustion engines, however, the fuel cell system operates in a manner fundamentally independent of mechanical influences on the tractor and instead operates solely on the basis of the operating parameters of the fuel cell.

By virtue of the fact that, according to the disclosure, use is made of the operating parameters of the overall system and optionally, in addition, operating parameters from the route-section information, the fuel cell system can respond appropriately to any specific trailer which contributes its own electric machine and its own electric storage device and can adapt the amount of generated power that it provides accordingly, that is, can generally reduce it. This leads over the long term to better efficiency of the fuel cell system, which can be operated more efficiently at lower operating points than at higher operating points. By virtue of the predictive allowance for the route-section information, it is possible, for example, for the tractor to ramp down the fuel cell system at an earlier point on an uphill slope in the knowledge that the uphill slope will be followed by a relatively long downhill section and that, there, in the regeneration mode, it will be possible for electric energy to be provided both by the first and by the second electric machine and to be transferred to the electric storage devices, leading to a relief of the load on the fuel cell system.

In another embodiment, the operating parameters including:
total capacity, total state of charge and/or maximum possible charging power of the first and/or the second electric storage device are determined
by interrogating a battery management system of the vehicle, and the operating parameters are transmitted to the fuel cell controller of the fuel cell system. Transmission can take place via a BUS system in the commercial vehicle, for example, a CAN BUS. Transmission by wireless communication, for example, by radio transmission, between a fuel cell controller and the battery management system is also envisaged in various embodiments. Transmission by wireless link can be accomplished via Bluetooth connections, ISM connections or SRD connections, for example. As an alternative, wireless transmission can take place via network transmission standards such as WLAN.

In other embodiments, the trailer is connected to the tractor by a dedicated LAN cable, referred to as an automotive Ethernet, and the data relating to the operating parameters can be transmitted via this cable to the tractor and, optionally, to the fuel cell controller there.

In various embodiments, the battery management system is integrated into the tractor or the electronic brake controller thereof, or into an electronic brake controller of the trailer. The electronic braking systems of the tractor and of the trailer communicate with one another during the control of braking in the overall system and preferably coordinate both the regenerative braking by the electric machines in the regeneration mode and the activation of the friction brakes or the operation of retarders.

In another embodiment, the operating parameters including:
total capacity of the first and the second electric storage device, maximum driving power of the first and/or the second electric machine, and/or maximum regenerated power of the first and/or the second electric machine
are determined by reading information elements on the vehicle combination, in particular one or more barcodes.

In another embodiment, the total capacity of the first and the second electric storage device, and/or the total regenerated power of the first and the second electric machine, are/is calculated by the fuel cell controller, or calculated by a trailer or tractor braking control unit and transmitted to the fuel cell controller via data transfer.

In another embodiment, which is, at the same time, a second, independent aspect of the disclosure, the method includes, preferably in addition to the above-described embodiments, or in isolation, the following steps:
changing from the normal operating mode to the regeneration mode at a switchover point, and
ramping down the generated power of the fuel cell system before the switchover point, at the switchover point or within a predetermined (first) delay period after the switchover point.

The first delay period is preferably in a region of 3.0 seconds or less, as a further preference 2.0 seconds or less.

In this aspect of the disclosure, it is above all the adaptation of the generated power provided by the fuel cell system in the regeneration mode that is addressed. Owing to the initially addressed limited dynamic response in the operation of the fuel cell systems, these cannot be stepped down suddenly from one operating point to a lower power level during continuous operation, nor switched off, without accepting damage to the fuel cell systems. Instead, it is necessary to ramp down the generated power over a certain time in order to avoid damage. At the time, therefore, when a switch is made from a normal operating mode to a regeneration mode, for example, when a braking command occurs, or at the beginning of a downhill slope defined in advance in the context of the operating strategy, it is generally the case that, at the beginning of regeneration, there is transmission in the direction of the electric storage devices both of the regenerated energy by the electric machines and, as before, by the fuel cell system.

As explained above, however, the maximum charging power of the electric storage devices is limited. It is not possible for an arbitrary amount of electric energy per unit time to be absorbed by the electric storage devices. This maximum charging power is determined inter alia by the charging rate, which is also referred to as the C rate. Some of the maximum possible charging power for an electric storage device is “taken up” by the generated power provided by the fuel cell, and therefore it is sometimes not possible for the electric machines to feed their actual full regenerated power into the electric storage devices. It is here that the disclosure intervenes in this second aspect by proposing to systematically ramp down the generated power from the fuel cell system when the vehicle changes from the normal operating mode to the regeneration mode at the switchover point.

In the context of the operating strategy, it may also be preferred if the fuel cell begins to ramp down the generated power provided by the fuel cell even before the switchover point, if this is known in the context of the operating strategy. The earlier this step of ramping down is initiated, the sooner the full regeneration potential of the electric machines can be exploited in the regeneration mode.

In the case of switchover points that are not predetermined but are determined on the basis of urgent braking requests by the driver or an electronic braking system, this switchover point coinciding with the braking command is preferably used as a trigger for ramping down the generated power. The extent to which the fuel cell system takes up the maximum charging power of the electric storage device is thus deliberately reduced to enable the first electric machine and thus the commercial vehicle combination as a whole to exploit the full regeneration potential as well.

To ensure that there is as much leeway and as much time as possible available for ramping down the fuel cell, the operating strategy in its embodiment is set in such a way that, at the switchover point, there is already free capacity in the first electric storage device and/or in the second electric storage device, that is, that the state of charge thereof is below the respective total capacity of the electric storage devices, even at the switchover point.

In an embodiment, regenerated power is initially provided only via the second electric machine from the switchover point, the power being fed, in particular, to the second electric storage device, and it is only after this that regenerated power is provided via the first electric machine, and fed, in particular, to the first electric storage device. Since the regeneration is cascaded through the electric machines and, initially, only the second electric machine of the trailer is used for regenerative braking in the regeneration mode, the fuel cell system can be ramped down gently in order to relieve the load on the electric storage devices, and, in particular, on the first electric storage device, before regeneration via the first electric machine begins. If it is then the case that, in addition to the trailer, the tractor also begins to transfer the regenerated energy to the first electric storage device via the electric machine, the generated power provided by the fuel cell system has already fallen quite a lot, with the result that less “bandwidth” of the maximum charging power that can be absorbed by the battery is taken up by the generated power, and a higher regenerated power can be fed in.

Fundamentally, it is the case that, the earlier ramping down of the charging power of the fuel cell system is started, the greater are the regeneration potentials of the two electric machines in the regeneration mode and the more time is available for ramping down the generated power of the fuel cell system, which has a positive effect on its service life.

In various embodiments, the second delay period, that is, the time from the switchover point, in which regenerated power is initially provided only via the second electric machine, which is preferably assigned to the trailer, is in a region of up to 5 seconds, as a further preference in a region of up to 2 seconds.

In other embodiments, the time is in the region of one or more seconds before the switchover point.

In another embodiment, the vehicle combination has a retarder and, in the regeneration mode, from the switchover point, regenerated power is initially provided only via the first and/or the second electric machine, as in the above-described embodiments for example, in particular until the state of charge of the first and/or the second electric storage device has reached a predetermined value, for example, its respective maximum capacity, and only then is the retarder actuated. If even more braking energy then has to be applied, because the braking power applied up to this point is not sufficient, deceleration can be continued additionally via the friction brake of the vehicle combination.

The invention has been described above with reference to the method according to the disclosure. In a further aspect, the disclosure also relates to a commercial vehicle combination including a tractor, which has a first electric machine and a first electric storage device operatively connected to the latter, and a fuel cell system, which is connected to the first electric storage device and is configured to provide the first electric storage device with electric energy with a generated power.

The disclosure achieves its underlying object in the case of a commercial vehicle combination of this kind in that the first and/or the second electric machine are/is configured to drive the commercial vehicle combination in a normal operating mode while drawing electric energy with a driving power from the first and/or the second electric storage device, and/or, in a regeneration mode, to provide electric energy with a regenerated power and to feed it to the first and/or the second electric storage device, and wherein the commercial vehicle combination has a vehicle controller, which is connected in a signal-transmitting manner to the electric machines and the electric storage devices and is configured to carry out the method according to any one of the embodiments described above.

In particular, the vehicle controller has a fuel cell controller, wherein the fuel cell controller is configured to operate the fuel cell system to provide the generated power, wherein the vehicle controller is configured
a) to operate the electric machines to drive the commercial vehicle combination in a normal operating mode while drawing electric energy from the electric storage devices, or
b) to operate the electric machines to provide electric energy with a regenerated power and to feed the energy to the electric storage devices in a regeneration mode; and the fuel cell controller is configured
to determine operating parameters of the first and the second electric machine and/or operating parameters of the first and the second electric storage device; and to operate the fuel cell system so as to adapt the generated power as a function of one or more or all of the operating parameters determined.

The commercial vehicle combination exploits the same advantages as the above-described method according to the disclosure. The embodiments of the method are simultaneously embodiments of the commercial vehicle combination and vice versa, for which reason attention is drawn to the above embodiments in order to avoid repetition.

### BRIEF DESCRIPTION OF DRAWINGS

The invention will now be described with reference to the drawings wherein:

FIG. 1 shows a schematic illustration of a commercial vehicle combination according to an embodiment;

FIG. 2 shows a diagrammatic method sequence according to the prior art for the operation of a commercial vehicle combination; and,

FIGS. 3 to 6 show various diagrammatic method sequences of the method according to the disclosure.

### DETAILED DESCRIPTION

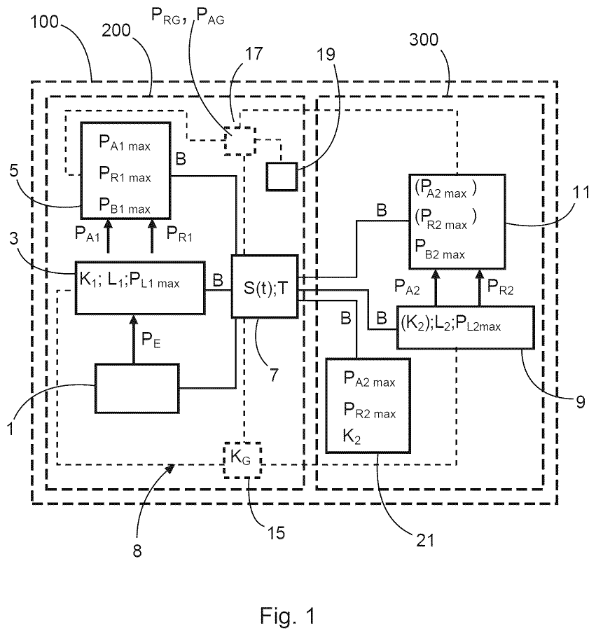

FIG. 1 illustrates the schematic fundamental construction of a commercial vehicle combination 100. The commercial vehicle combination 100 has a tractor 200 and a trailer 300.

The tractor 200 has a fuel cell system 1, which is configured to provide electric energy with a generated power P_{E}.

The tractor 200 furthermore has a first electric storage device 3, which is operatively connected to the fuel cell system 1 and is configured to temporarily store the generated power P_{E} provided by the fuel cell system 1.

The tractor 200 furthermore has at least one first electric machine 5, which is operatively connected to the first electric storage device 3. The at least one first electric machine 5 is configured, in a normal operating mode N, to drive the tractor 200 while drawing electric driving energy with a first driving power P_{A1} from the first electric storage device 3 and, in a regeneration mode R, during what is referred to as regenerative braking, to recover electric regenerated energy with a regenerated power P_{R1} from the moving tractor 200 and feed it to the first electric storage device 3.

The tractor 200 has a vehicle controller 8, which is configured to operate the electronic components of the commercial vehicle combination 100 for the operation thereof. The vehicle controller 8 preferably has a plurality of control units, including a fuel cell controller 7, which is configured to operate the fuel cell system 1. Here, the fuel cell controller 7 is depicted as a separate unit but could also be integrated structurally into some other component, in particular the fuel cell system 1. The fuel cell controller 7 is configured to adapt the amount of generated power P_{E} provided by the fuel cell system 1 by controlling the fuel cell system 1.

In addition to the first electric storage device 3 arranged in the tractor 200, the commercial vehicle combination 100 has at least one second electric storage device 9, which is assigned to the trailer 300. The trailer 300 furthermore has at least one second electric machine 11, which is operatively connected to the second electric storage device 9.

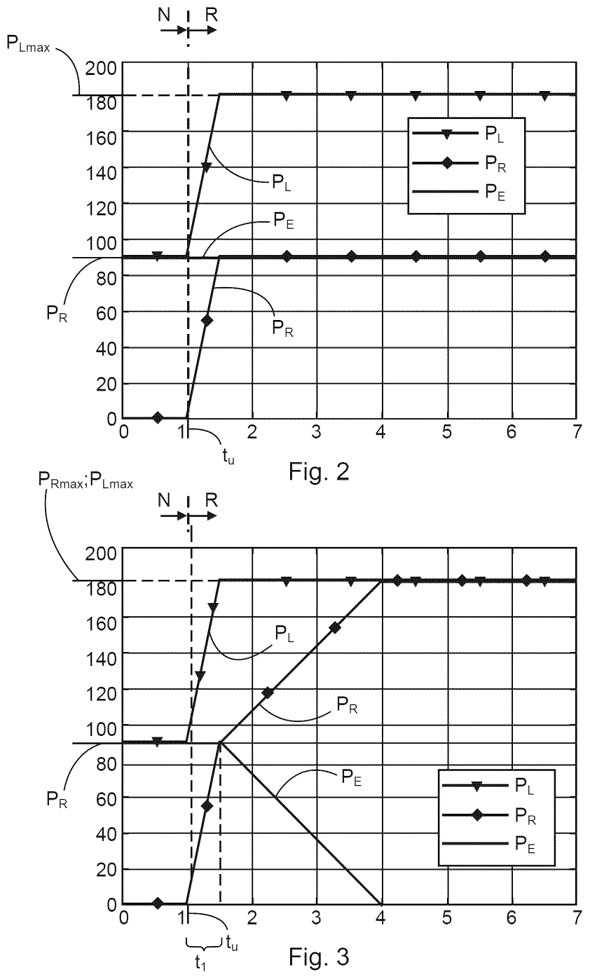

The second electric machine 11 is configured, in a normal operating mode N, cf. FIGS. 2 to 6, to drive the trailer 300 while drawing electric energy with a driving power P_{A2} and, in a regeneration mode R, cf. FIGS. 2 to 6, to recover electric energy with a regenerated power P_{R2} from the moving trailer 300 and feed it to the second electric storage device 9.

In the coupled state of the tractor 200 and the trailer 300, the commercial vehicle combination 100 is driven at least temporarily both by the first electric machine 5 and also by the second electric machine 11 in the normal operating mode N. A total driving power P_{AG}=P_{A1}+P_{A2} is available for this purpose. In the regeneration mode R, energy can similarly be recovered both from the first electric machine 5 and from the second electric machine 11, with a total regenerated power P_{RG}=P_{R1}+P_{R2}, where P_{R1} is contributed by the tractor 200 and P_{R2} is contributed by the trailer 300.

The fuel cell controller 7 is connected in a signal-transmitting manner to the electric storage devices 3, 9 and to the electric machines 5, 11 and is configured to receive representative data for electric operating parameters B of the electric storage devices 3, 9 and/or of the electric machines 5, 11. These operating parameters include a capacity K₁ of the first electric storage device 3, a capacity K₂ of the second electric storage device 9, a state of charge L₁ of the first electric storage device 3, a state of charge L₂ of the second electric storage device 9, the driving powers P_{A1} and P_{A2} of the electric machines 5, 11, the regenerated powers P_{R1}, P_{R2} of the electric machines 5, 11, maximum driving powers P_{A1max} and P_{A2max}, maximum regenerated powers P_{R1max} and P_{R2max} of the electric machines 5, 11, maximum charging powers P_{L1max}, P_{L2max} of the electric storage devices 3 and 9 and/or the maximum braking powers P_{B1max}, P_{B2max} of the electric machines 5, 11.

The vehicle controller 8 furthermore preferably has a braking controller 17, which, for its part, can have a plurality of control units (not shown specifically), for example, a tractor braking control unit (EBS) assigned to the tractor 200 and a trailer braking control unit (TEBS) assigned to the trailer 300. For better understanding of the disclosure, only braking control unit 17 is illustrated by way of example in FIG. 1. The vehicle controller 8 is configured, in the normal operating mode N, to operate the electric machines 5, 11 to drive the commercial vehicle combination 100 and, in the regeneration mode R, to operate them to generate electric energy with a regenerated power P_{R1} and P_{R2}, respectively, and to use the braking controller 17 for this purpose, for example.

Most especially, the fuel cell controller 7 is configured to operate the fuel cell system 1 in such a way as a function of the electric operating parameters B determined that the generated power P_{E} is adapted in accordance with the operating parameters B determined.

To determine the electric operating parameters B, the fuel cell controller 7 can be directly connected in a signal-transmitting manner to the electric storage devices 3, 9, or alternatively or additionally connected in a signal-transmitting manner to a battery management system 15, which is part of the vehicle controller 8 and, for its part, is connected in a signal-transmitting manner to the electric storage devices 3, 9 and is configured to receive the individual operating parameters B from the electric storage devices 3, 9 and to compute them either individually or together and transmit them to the fuel cell controller 7.

As an option, the commercial vehicle combination 100 has one or more retarders 19, and the vehicle controller 8 is configured to operate this/these to carry out a continuous braking function, for example, under the control of the braking controller 17.

During the operation of the commercial vehicle combination 100, the method according to the disclosure described in more general terms above is employed. In an illustrative operating sequence, the commercial vehicle combination 100 is moved in a normal operating mode N. The fuel cell system 1 generates electric energy with a generated power P_{E}. The energy provided with the generated power P_{E} is temporarily stored in the first electric storage device 3, ensuring that the latter is at a state of charge L₁, which is less than or equal to the maximum capacity K₁ of the electric storage device 3. P_{E} can be less than or equal to the maximum charging power P_{L1max}. The first electric machine 5 makes available the driving power P_{A1} while drawing electric energy from the electric storage device 3, via which energy the tractor 200 is driven.

The second electric machine 11 makes available the driving power P_{A2} while drawing electric energy from the second electric storage device 9, wherein the driving power P_{A2} is less than or equal to the maximum driving power P_{A2max} of the second electric machine 11. The trailer 300 is driven via this driving energy P_{A2}, and therefore the total driving power P_{AG} of the commercial vehicle combination 100 is P_{A1}+P_{A2}.

When a switchover is made from the normal operating mode N to the regeneration mode R at a switchover point t_{U}, cf. FIG. 2 to FIG. 6, when the commercial vehicle combination 100 is driving down a slope, for example, and/or a braking operation is being carried out, the electric machines 5, 11 are operated as generators. This procedure is known as regenerative braking or regeneration. In this regeneration mode R, the first electric machine 5 generates electric energy with a regenerated power P_{R1} and feeds it to the first electric storage device 3, while the second electric machine 11 makes available the regenerated power P_{R2} provided by it to the second electric storage device 9.

During the operation of the commercial vehicle combination 100, preferably both in the normal operating mode N and in the regeneration mode R, the fuel cell controller 7 determines the above-described operating parameters B of the electric storage devices 3, 9 and the electric machines 5, 11 and adapts the generated power P_{E} of the fuel cell system 1 as a function of the operating parameters B.

For example: The more regenerated power P_{R1} can be provided by the first electric machine 5, the further the generated power P_{E} can be lowered in order nevertheless to keep the first electric storage device 3 at a sufficient state of charge L₁ to operate the commercial vehicle combination 100. In addition, the contribution of the trailer 300 to the propulsion of the commercial vehicle combination 100 in the normal operating mode N, and the contribution of the trailer 300 to the recovery of energy via the regenerated power P_{R2} in the regeneration mode R, is reported to the fuel cell controller 7 by the second electric machine 11 by way of the operating parameters B.

Some of the operating parameters B of the trailer 300 cannot be determined during continuous operation but relate to characteristic operating variables that are characteristic of the electric machine 11 and the electric storage device 9 of the trailer 300, for example, the capacity K₂ of the second electric storage device 9 installed in the trailer 300 but optionally also the maximum charging power P_{L2max} of the second storage device 9 or the maximum driving power P_{A2max} of the second electric machine 11. These operating parameters can be stored as fixed parametric values in the trailer 300 and transmitted to the fuel cell controller 7, for example, by data exchange. However, it is also possible, for example, for the information elements to be assigned to an information element 21, which is arranged, for example, as an RFID element in the region of coupling of the trailer 300 to the tractor 200, or can be in the form of one or more barcodes, which are placed on the trailer 300 and are read in when the trailer 300 is connected to the tractor 200.

The fuel cell controller 7 preferably additionally controls the fuel cell system 1 via an operating strategy S(t) along a time characteristic (t), wherein, as a further preference, the operating strategy S(t) includes a prediction of the driving power and/or the regenerated power along the time characteristic. The operating strategy S(t) furthermore preferably includes a prediction of the states of charge L₁, L₂ of the electric storage devices 3, 9 along the time characteristic (t). For the operation of the commercial vehicle combination 100, the fuel cell controller 7 determines, either in advance or continuously during the normal operating mode N and/or the regeneration mode R, route-section information T from the vehicle controller 8, for example, from a fleet management system of the tractor 200 or from a topographic navigation system, and, in addition to taking account of the operating parameters B, additionally adapts the generated power P_{E} in accordance with the route-section information T determined.

The fuel cell controller 7 requests the following operating parameters B: total capacity K_{G}=K₁+K₂; and/or maximum charging power P_{Lmax}=P_{L1max}+P_{L2max} either directly from the electric storage devices 3, 9 and/or by requesting them from the battery management system 15.

The total capacity K_{G}, the total driving power P_{AG}, and/or the total regenerated power P_{RG} can be calculated by the fuel cell controller 7 or calculated separately, for example, by the braking controller 17 or the battery management system 15, and transmitted to the fuel cell controller 7 via data transfer.

One particular aspect of the method will be explained in greater detail below with reference to FIGS. 2 to 6.

FIG. 2 schematically illustrates the operation of a commercial vehicle according to the prior art. The commercial vehicle according to the prior art has a fuel cell system that is operated at a constant generated power P_{E} of about 90 kW. This power is the approximate power necessary to move a fully loaded commercial vehicle combination of about 40 tonnes on a level route-section at a speed of about 80 km/h. By way of example, it is assumed that the electric storage device of the prior-art commercial vehicle has a drive battery with a capacity of 120 kWh. At a charging rate of 1.5 C, this battery could be charged at a maximum charging power P_{Lmax} of 180 KW. However, because the fuel cell system is already introducing energy constantly into the electric storage device with 90 kW of generated power P_{E}, only the difference between the maximum charging power P_{Lmax} and the generated power P_{E}, that is, 90 KW, is available as regenerated power P_{R} for regeneration, which begins at a switchover point t_{U}.

In contrast, the disclosure relies on adapting the generated power P_{E}. Applied to a generic setup, initially without distinction between a tractor and a trailer, as illustrated in FIG. 3, a switch is made at a switchover point t_{U} from the normal operating mode N to the regeneration mode R, and the battery of the commercial vehicle is supplied with electric energy with a regenerated power P_{R} in addition to the generated power P_{E} until the maximum charging power P_{Lmax} is reached. For as long as P_{E} is held unchanged at 90 kW, it is not possible to achieve a regenerated power higher than 90 kW. After the expiry of a delay period t₁ of about half a second after the switchover point t_{U}, however, the fuel cell system is operated in such a way as to lower the generated power P_{E}. As a result, it is possible to further increase the regenerated power P_{R}.

In the idealized example in FIG. 3 and in the subsequent figures, the generated power P_{E} is in each case lowered to 0, which would be equivalent to shutting down the fuel cell system. In practical applications, the power P_{E} is preferably adjusted to a reduced power level greater than 0 that is favorable for the wear behavior and the service life of the fuel cell system. In principle, however, a full shutdown of the fuel cell system and consequently lowering of P_{E} to 0 is also possible.

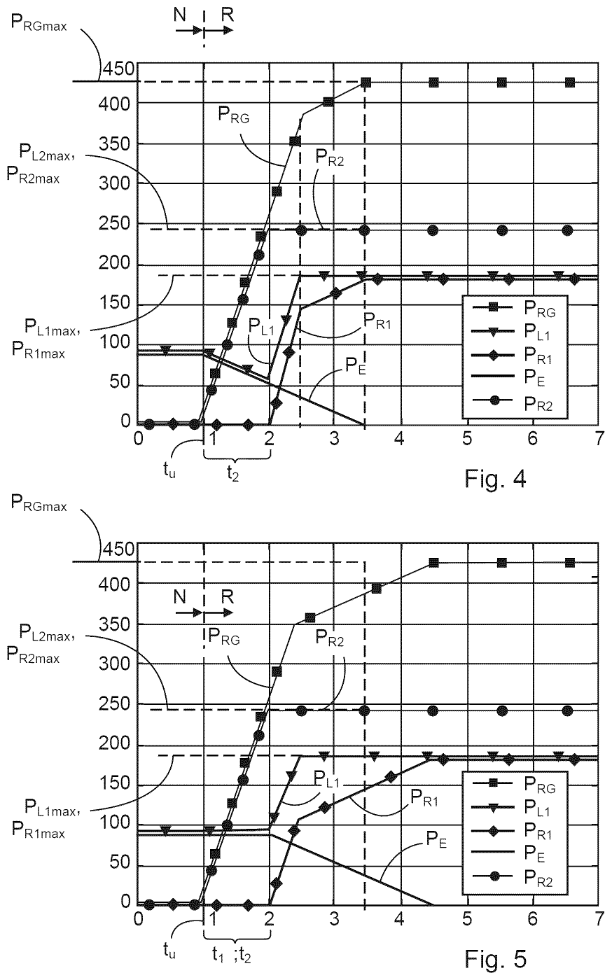

The fundamental concept illustrated in FIG. 3 is shown in more detail in FIG. 4 with the addition of a visualization of the operation of both electric storage devices 3, 9 of the commercial vehicle combination 100 according to FIG. 1. The second electric storage device 9 of the trailer 300 has, for example, a capacity K₂ of 40 kWh at a Crate of 6 C, resulting in a maximum charging power of the second electric storage device 9 of 240 KW (P_{L2max}). In this embodiment, therefore, the commercial vehicle combination 100 could absorb a maximum regenerated power P_{R2max} of the same level from the second electric machine 11 as well, and consequently a total regenerated power P_{RGmax} of 330 kW if the fuel cell system 1 were operated constantly at P_{E}=90 kW. Here too, however, the maximum regenerated power P_{RGmax} that can be absorbed is further optimized as follows, by adapting the generated power P_{E}: As in FIG. 3, a switch is made from the normal operating mode N to the regeneration mode R at time t_{U}. The second electric machine 11 begins regeneration immediately at time t_{U}, and makes available the regenerated power P_{R2}.

After a time t₂, the first electric machine 5 also begins to make available the regenerated power P_{R1}. From time t_{U}, the fuel cell system 1 is already being operated in such a way that the generated power P_{E} is (gently) ramped down. Thus, after the passing of time t₂, a higher regenerated power P_{R1} can already be provided by the first electric machine 5 than would be possible when exploiting the maximum charging power P_{L1max} of the first electric machine 5 if P_{E} had not been ramped down.

In this way, the maximum achievable total regenerated power P_{RGmax} is successively optimized.

As is already shown by the comparison of the previous figures, it is advantageous for maximum exploitation of the regeneration potential of the commercial vehicle combination 100 to reduce the generated power P_{E} as early as possible as part of the operating strategy S(t) if there is knowledge of an imminent switchover point t_{U}, that is, quite possibly even before the switchover point t_{U}.

However, the invention is also advantageous when the generated power P_{E} is ramped down only after the switchover point t_{U}, as FIG. 5 illustrates by way of example.

In the method sequence sketched diagrammatically in FIG. 5, the fuel cell system 1 is operated to provide a constant generated power P_{E} in the normal operating mode N, where P_{E} is below the maximum charging power P_{L1max} of the first electric storage device 3. At the switchover point t_{U}, a switch is made to the regeneration mode R and, at the same time, the second electric machine 9 begins to provide the regenerated power P_{R2}. With a delay period in a time t₁ after the switchover point t_{U}, the fuel cell system 1 is then operated to ramp down the generated power P_{E}. At the same time, the first electric machine 5 begins to provide the regenerated power P_{R1}. The rise in the regenerated power P_{R1} is slowed at the moment at which the charging power P_{L1} reaches its maximum P_{L1max} but, owing to the continued adaptation of the generated power P_{E}, it continues to rise until, in this embodiment too, the maximum total regeneration potential P_{RGmax} can finally be fully exploited after a few seconds. As in the embodiment in FIG. 4, there is a time t₂ between the beginning of regeneration by the second electric machine 11 and the first electric machine 5.

In the case where, despite the full exploitation of a maximum regenerated power P_{RGmax}=P_{R1max}+P_{R2max} over a deceleration process in the regeneration mode R, an additional braking action is necessary, it is additionally possible, after the full exploitation of the regeneration potentials, for the retarder 19 to be activated by the vehicle controller 8 or braking controller 17 and, if even this is not sufficient to decelerate the commercial vehicle combination 100, the friction brakes can then additionally be activated.

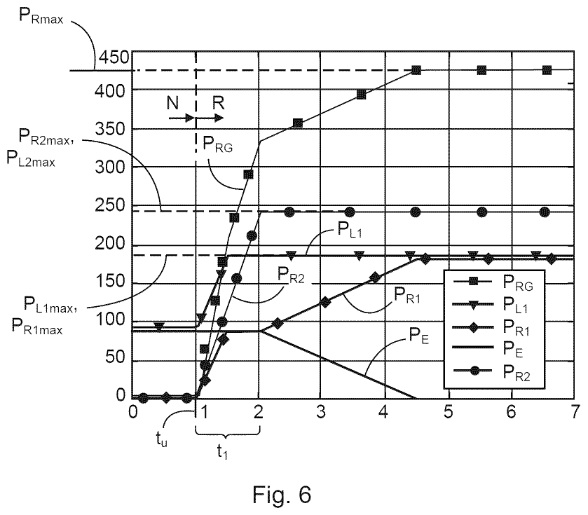

In the illustrative method sequence according to FIG. 6, in contrast to the embodiment according to FIG. 5, regeneration does not begin in a cascaded fashion from the switchover point t_{U} but instead simultaneously at the switchover point t_{U}, and therefore, in comparison with FIG. 5, the rise in the total regenerated power P_{RG} is steeper than in the variant according to FIG. 5. The ramping down of the generated power P_{E} begins within the time of the delay period t₁ after the switchover point, in the present case approximately 1 second. The attenuation of the rise in the total regenerated power P_{RG} starts earlier, and the characteristic is then somewhat flatter than in the method sequence according to FIG. 5, but ultimately the same maximum total regenerated power P_{RGmax} as in FIG. 5 is achieved.

As is apparent from the above, the application of the principles of the disclosure leads to a lower generated power P_{E} and hence to lower consumption of reactants during the operation of the fuel cell system 1. Moreover, by virtue of this improved exploitation of the regeneration potentials of the electric machines, energy is recovered during the operation of the commercial vehicle combination 100, and the wear on the friction brakes of the commercial vehicle combination 100 can be reduced.

It is understood that the foregoing description is that of the preferred embodiments of the disclosure and that various changes and modifications may be made thereto without departing from the spirit and scope of the disclosure as defined in the appended claims.

### LIST OF REFERENCE SIGNS (PART OF THE DESCRIPTION)

1 fuel cell system
3 first electric storage device
5 first electric machine
7 fuel cell controller
8 vehicle controller
9 second electric storage device
11 second electric machine
15 battery management system
17 brake controller
19 retarder
21 information element
100 commercial vehicle combination
200 tractor
300 trailer
B operating parameter
K₁, K₂ capacity of first/second electric storage device
K_{G} total capacity
L₁, L₂ state of charge of first/second electric storage device
N normal operating mode
P_{A1}, P_{A2} driving power of first/second electric machine
P_{A1max}, P_{A2max} maximum driving power of first/second electric machine
P_{AG} total driving power
P_{B1max}, P_{B2max} maximum braking power of first/second electric machine
P_{E} generated power (fuel cell system)
P_{L1max}, P_{L2max} maximum charging power of first electric storage device
P_{R}, (P_{R1}, P_{R2}) regenerated power (first/second electric storage device)
P_{R1max}, P_{R2max} maximum regenerated power of first/second electric machine
P_{RG} total regenerated power
P_{RGmax} maximum total regenerated power
R regeneration mode
S(t) operating strategy
T route-section information
(t) time characteristic
t_{U} switchover point

1. A method for operating a commercial vehicle combination, the vehicle combination including a tractor and a trailer, the tractor having a first electric machine, a first electric storage device operatively connected to the first electric machine, and a fuel cell system operatively connected to the first electric storage device, the fuel cell system being configured to provide electric energy with a generated power, the trailer having a second electric machine and a second electric storage device operatively connected to the second electric machine, the method comprising:
determining operating parameters of at least one of the first electric machine, the second electric machine, the first electric storage device, and the second electric storage device; and,
adapting the generated power of the fuel cell system as a function of at least one of the determined operating parameters.

2. The method of claim 1 further comprising:
providing the generated power via the fuel cell system; and at least one of:
a) driving the commercial vehicle combination in a normal operating mode while drawing electric energy with a driving power from at least one of the first electric storage device and the second electric storage device; and,
b) providing electric energy with a regenerated power via at least one of the first electric machine and the second electric machine, and feeding the energy to at least one of the first electric storage device and the second electric storage device in a regeneration mode.

3. The method of claim 1, wherein the operating parameters include at least one of:
i) total capacity of the first electric storage device and of the second electric storage device;
ii) total state of charge of the first electric storage device and of the second electric storage device;
iii) total driving power of the first electric machine and of the second electric machine;
iv) total regenerated power of the first electric machine and of the second electric machine;
v) maximum first driving power of the first electric machine;
vi) maximum second driving power of the second electric machine;
vii) maximum first regenerated power of the first electric machine;
iix) maximum second regenerated power of the second electric machine;
ix) maximum first charging power of the first electric storage device;
x) maximum second charging power of the second electric storage device;
xi) maximum first braking power of the first electric machine; and,
xii) maximum second braking power of the second electric machine.

4. The method of claim 1, wherein the generated power is adapted in accordance with an operating strategy, wherein the operating strategy has a time characteristic.

5. The method of claim 4 further comprising:
providing the generated power via the fuel cell system; and at least one of:
a) driving the commercial vehicle combination in a normal operating mode while drawing electric energy with a driving power from at least one of the first electric storage device and the second electric storage device;
b) providing electric energy with a regenerated power via at least one of the first electric machine and the second electric machine, and feeding the energy to at least one of the first electric storage device and the second electric storage device in a regeneration mode; and,
wherein the operating strategy includes a prediction of at least one of the driving power and the regenerated power along the time characteristic.

6. The method of claim 4, wherein the operating strategy includes a prediction of at least one of a state of charge of the first electric storage device and a state of charge of the second electric storage device along the time characteristic.

7. The method of claim 6, wherein the prediction relates to changes in at least one of the state of charge of the first electric storage device and the state of charge of the second electric storage device occurring along the time characteristic.

8. The method of claim 4 further comprising:
determining route-section information along the time characteristic; and,
adapting the generated power additionally as a function of the route-section information determined.

9. The method of claim 1, wherein said determining at least one of a total capacity, a total state of charge, and a maximum possible charging power as the operating parameters of at least one of the first electric storage device and the second electric storage device is achieved by interrogating a battery management system, and the operating parameters are transmitted to a fuel cell controller of the fuel cell system.

10. The method of claim 1, wherein the operating parameters include at least one of a total capacity of the first electric storage device and of the second electric storage device, a maximum driving power of the first electric machine, a maximum driving power of the second electric machine, a maximum regenerated power of the first electric machine, a maximum regenerated power of the second electric machine and are determined by reading information elements on the commercial vehicle combination.

11. The method of claim 1, wherein a total capacity of the first electric storage device and the second electric storage device, and/or a total regenerated power of the first electric machine and of the second electric machine, is calculated by a fuel cell controller.

12. The method of claim 4 further comprising:
changing from a normal operating mode to a regeneration mode at a switchover point; and,
ramping down the generated power before the switchover point, at the switchover point, or within a predetermined first delay period after the switchover point.

13. The method of claim 11, wherein the generated power is controlled such that a total state of charge of the first electric storage device and the second electric storage device at the switchover point is below a total capacity.

14. The method of claim 13, wherein, from the switchover point, regenerated power is initially provided only via the second electric machine for a second delay period.

15. The method of claim 14, wherein the regenerated power is fed to the second electric storage device.

16. The method of claim 14, wherein only after said second delay period that the regenerated power is provided via the first electric machine.

17. The method of claim 16, wherein the regenerated power provided via the first electric machine is fed to the first electric storage device.

18. The method of claim 14, wherein the second delay period from the switchover point, in which initially regenerated power is provided only via the second electric machine, is 5.0 seconds or less.

19. The method of claim 12, wherein the commercial vehicle combination has a retarder and, in the regeneration mode, from the switchover point, regenerated power is initially provided only via at least one of the first electric machine and the second electric machine, and only then is the retarder actuated.

20. The method of claim 4, wherein the commercial vehicle combination has a retarder; and, a ramping down of the generated power via the fuel cell system is initiated with an activation of the retarder.

21. A commercial vehicle combination comprising:
a tractor having a first electric machine and a first electric storage device operatively connected to said first electric machine;
a trailer having a second electric machine and a second electric storage device operatively connected to said second electric machine;
a fuel cell system operatively connected to said first electric storage device and being configured to provide electric energy with a generated power;
at least one of said first electric machine and said second electric machine being configured to drive the commercial vehicle combination in a normal operating mode while drawing the electric energy with a driving power from at least one of said first electric storage device and said second electric storage device and in a regeneration mode, to provide the electric energy with a regenerated power and to feed said regenerated power to at least one of said first electric storage device and said second electric storage device;
a vehicle controller being connected in a signal-transmitting manner to said first electric machine, said second electric machine, said first electric storage device, and said second electric storage device; and,
said vehicle controller being configured to:
determine operating parameters of at least one of said first electric machine, said second electric machine, said first electric storage device, and said second electric storage device; and,
adapt the generated power of said fuel cell system as a function of at least one of the determined operating parameters.

22. The commercial vehicle combination of claim 21, wherein said fuel cell system is arranged on said tractor.
